(19) United States
(12) Patent Application Publication
(10) Pub. No.: US 2006/0260896 A1
(43) Pub. Date: Nov. 23, 2006

(54) Freewheel

(75) Inventor: Stefan Jung, Kehl (DE)

Correspondence Address: DAVIDSON, DAVIDSON & KAPPEL, LLC, 485 SEVENTH AVENUE, 14TH FLOOR, NEW YORK, NY, 10018, US

(73) Assignee: LuK Lamellen und Kupplungsbau Beteiligungs KG, Buehl (DE)

(21) Appl. No.: 11/431,370

(22) Filed: May 10, 2006

(30) Foreign Application Priority Data
May 19, 2005 (DE) DE 102005022906.9

(51) Int. Cl. F16D 41/12

(52) U.S. Cl. 192/46

(57) ABSTRACT

A freewheel of a torque converter stator contains blocking elements that must rotate by an angle of rotation before the blocking function is initiated. They may be blocking elements that pivot about an axis parallel to the stator axis. In another embodiment, a blocking element pivots about an axis identical to the stator axis. In this case, ramps of this blocking element wedge against ramps of the freewheel outer ring.

This claims the benefit of German Patent Application No. 10 2005 022 906.9 filed May 19, 2005 and hereby incorporated by reference herein.

### BACKGROUND INFORMATION

The present invention relates to a freewheel for the directional torque transmission of a stator in a torque converter made up of a stator and a freewheel unit, including a rotating outer ring, a rotating inner ring situated concentric to the outer ring, and a plurality of transmission elements situated between the outer ring and inner ring at the periphery of running surfaces, with the aid of which the stator can be brought into a torque transmission position or a freewheel position in relation to the inner ring.

A torque converter is known, for example, from U.S. Pat. No. 5,771,998, hereby incorporated by reference herein.

Freewheel systems are used in the most diverse technical fields. Generally known are freewheels in which the rotary motion is transmitted by a frictional connection in one direction and no transmission of motion occurs in the opposite direction. The freewheel thus represents a clutch acting automatically as a function of the direction. In synchronized operation, the two clutch parts are joined together and torque transmission is possible. If the driving component lags behind, release, i.e., freewheeling, occurs. In order to fulfill the function of torque transmission in a torque converter, a stator must, among other things, rotate in one direction and block in the other direction. In such torque converters, roller-type freewheels or clamping element freewheels are generally used by placing cylindrical rollers in the running surface between an inner ring and an outer ring, and the inner running surface of the outer ring has sections, the rollers engaging with the surface of the sections, or the running surfaces of the inner and outer rings are cylindrical and non-round clamping elements are provided between the inner and outer ring, the clamping elements being in contact with the running surface under elastic force when the direction of rotation is reversed. DE 690 21 769 T2 describes a freewheeling clutch of the roller bearing type, the inner and outer part having identical or different shapes of running surfaces facing one another, the axes of the intermediate rolling bodies situated in the running surface being inclined at a predetermined angle in the direction of an area containing the common axis of the rotating inner and outer parts, so that in the freewheeling state of the clutch, the internal width of the running surface is enlarged by the movement of the intermediate rolling bodies against the narrowing action of the force unit, and when the direction is reversed, the internal width of the running surface is narrowed under the effect of the force unit, so that the clearance instantaneously becomes zero.

DE 40 03 220 A1 describes a freewheeling clutch having clamping elements guided in a cage, the clamping elements being situated between an outer ring and an inner ring, one outside circumferential surface having clamping element ramps which make it possible to adjust the clamping elements in two clutch engagement positions for the two directions of rotation using a shifting mechanism, and DE 40 32 330 A1 describes a freewheeling clutch for temporary torque transmission having two power transmission elements positioned coaxially to one another, in particular drive input wheels and drive output wheels, the outside one of which being provided with a star body surface as well as clamping elements and a control cage connected to the outer power transmission element with limited movability and which can be decelerated in relation to the rotational movement of the outer power transmission element using a stationary brake.

DE 35 01 610 C2 describes a freewheeling clutch having clamping elements as well as roller bodies, there being a predetermined relation between the wedge angle, the effective height of the clamping element blocks or the distance between the contact points of each clamping roller to the outer ring and inner ring for the transmission of a torque. In addition to frictionally engaging roller-type and clamping element freewheels, positively engaging freewheels are also known.

DE 42 02 086 C1 describes a freewheel device for all-wheel-drive motor vehicles, the two freewheel parts being connected via blocking bodies for torque transmission, shifting taking place via a shifting cage and the shifting cage being rotatable relative to the one freewheel part and having limited rotatability between two end positions relative to the other freewheel part and being supported against one another in the one end position by a spring connected to the shifting cage in a positively engaged connection and in the other end position in a frictionally engaged connection in the axial direction. Furthermore, DD 297 493 A5 describes a freewheel clutch in which it is possible to shift an outer part and an inner part relative to one another into a torque transmission position through pawls and the pawls being shifted synchronously into the engaging or disengaging position relative to the outer ring via control rings and a friction ring system engaging it.

The known freewheels, such as roller-type or clamping element freewheels, operate nearly clearance-free. However, this is not absolutely necessary for use in the stator.

### SUMMARY OF THE INVENTION

An object of the present invention is to design a freewheel for a stator in a torque converter, which in a simple manner makes a rotational movement of the stator possible in one direction and blocks its rotational movement in the other direction; however, the freewheel does not operate clearance-free when shifting from the freewheeling position to blocking and furthermore, the manufacturing costs for the freewheel are very low.

The present invention provides that transmission elements designed as blocking elements are positioned between a stator and an inner ring at the periphery of running surfaces, the transmission elements connecting the stator to the inner ring through a frictional or positive connection to the surface segments of the running surfaces for torque transmission in one direction and allowing a relative motion between the stator and the inner ring in the opposite direction.

It is advantageous that the blocking elements are designed as rotatably supported blocking elements at the periphery of the running surfaces, the outward pointing ends of the blocking elements being positively engaged with a wall of grooves situated in the stator and the inward pointing ends of the blocking elements being positively engaged with a wall of grooves situated in the inner ring, the blocking elements blocking the rotational movement when the stator is rotated counterclockwise and the blocking elements being pivoted if the direction of rotation of the stator is changed to freewheeling until the blocking elements are in contact with contact surfaces in recesses in the outer ring and the stator and the outer ring are rotating in the opposite direction of the inner ring in this end position of the blocking elements.

An advantageous embodiment is seen in that the blocking elements are designed as flat, in particular bone-like, molded elements and are provided at the periphery of the running surface of the freewheel.

The blocking elements are preferably supported in recesses of the outer ring, the contact surfaces of the recesses of the outer ring in particular being designed as bevels.

An advantageous refinement is seen in that different fits are provided between the inner ring, outer ring, and stator, so that the outer ring rotates somewhat more slowly than the stator in a change of direction, a clearance fit being provided in particular between the inner ring and the outer ring and a transition fit being provided in particular between the outer ring and the stator.

As opposed to the known freewheels, such as roller-type or clamping element freewheels that operate nearly clearance-free, the novel freewheel does not operate free of clearance when switching from freewheeling to blocking because this is not absolutely necessary for use in the stator. Furthermore, the manufacturing costs of the freewheel of the present invention are lower than in freewheels used heretofore.

It is also advantageously provided that the walls of the grooves in the inner ring and the walls of the grooves in the stator may be perpendicular to the axis of rotation of the freewheel, the grooves in the inner ring and the grooves in the stator being in particular designed to have beveled walls.

As a variation, it may also be provided that the blocking elements are supported and guided on the stator, springs being provided that press the blocking elements into the grooves situated in the inner ring during a change of direction, thus preventing movement between the stator and the inner ring. The advantage of this embodiment of the freewheel is that no outer ring is needed. Springs are needed for this version; however, the manufacturing costs of the springs are clearly lower than those of the outer ring without springs.

An advantageous version is seen in that the transmission elements may be designed as rollers, the rollers being situated on the periphery of the running surfaces and blocking the rotational movement if the stator is rotated in a counterclockwise direction, in that the rollers are pressed against inclined ramps of the outer ring in a frictional connection, the rotation of the stator in the freewheeling direction being detached from the clamped position of the inclined ramps in a change of direction, and the stator rotating in the opposite direction of the inner ring in an end position.

Preferably, spacers are provided between the rollers to set the location of the rollers to be engaged.

As a variation the rollers may also be situated in a one-piece ring.

### BRIEF DESCRIPTION OF THE DRAWINGS

The present invention will be explained in greater detail below with reference to schematic drawings of exemplary embodiments.

FIG. 1 shows a front view of a first exemplary embodiment of the freewheel according to the present invention;

FIG. 2 shows a detail of the first exemplary embodiment;

FIG. 3 shows a front view of a second exemplary embodiment of the freewheel of the present invention;

FIG. 4 shows a detail of the second exemplary embodiment;

FIG. 5 shows a detail of an additional exemplary embodiment of a freewheel.

### DETAILED DESCRIPTION

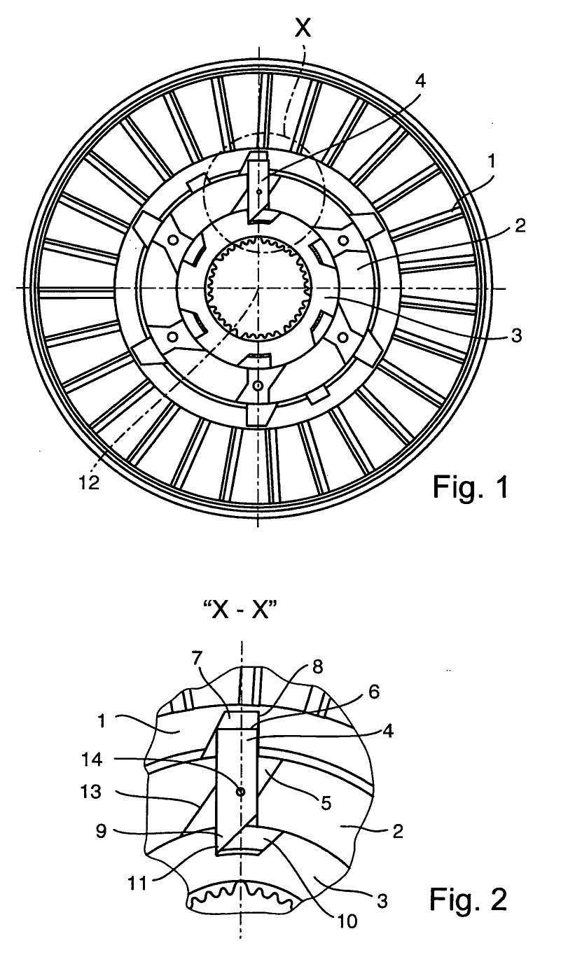

The first exemplary embodiment of a freewheel shown in FIG. 1 includes a stator 1, a rotating outer ring 2, a rotating inner ring 3 situated concentric to outer ring 2 and a plurality of transmission elements formed individually between outer ring 2 and inner ring 3 as blocking elements 4 situated on the periphery of running surfaces. Blocking elements 4 are provided as flat molded elements which are in particular bone-shaped. Individual blocking elements 4 are supported rotatably in provided recesses 5 of outer ring 2. When stator 1 is rotated to the left in a counterclockwise direction according to FIG. 2, blocking elements 4 block the rotational movement because the outward-pointing ends 6 of blocking elements 4 are in contact with walls 8 of grooves 7 situated in stator 1 and their inward-pointing ends 9 are in contact with walls 11 of grooves 10 situated in inner ring 3. Because walls 8 of grooves 7 situated in stator 1 and walls 11 of grooves 10 situated in inner ring 3 are perpendicular to an axis of rotation 12 of the freewheel, blocking elements 4 supported in outer ring 2 prevent a rotational movement between stator 1 and inner ring 3. The inner ring is in operating state.

If stator 1 is rotated to the right in freewheeling direction, blocking elements 4 supported in outer ring 2 pivot on bearing points 14 within recesses 5 and rotate to the right in clockwise direction. Outer ring 2 also rotates to the right until blocking elements 4 are in contact with contact surfaces of recesses 5 of outer ring 2 which are designed as bevels 13. This process is supported by centrifugal force which rotates blocking elements 4 on pivot points 14 and presses them onto corresponding bevels 13 of recesses 5 of outer ring 2. The position of pivot points 14 on blocking elements 4 must be designed in such a way that blocking elements 4 pivot and contact particular bevels 13 of recesses 5 on outer ring 2. If blocking elements 4 are in the end position, which is not described in greater detail, stator 1, blocking elements 4, and outer ring 2 rotate about inner ring 3. In this position, inward-pointing ends 9 of blocking elements 4 do not engage grooves 10 situated in inner ring 3. If a change of direction is made to the left in counterclockwise direction, stator 1 presses against blocking elements 4 and rotates them to the left on pivot points 14. In a change of direction from freewheeling to clamping, it is important for outer ring 2 to rotate somewhat more slowly than stator 1. This can be accomplished through different fits between inner ring 3 and outer ring 2 and stator 1, e.g., a clearance fit is provided between inner ring 3 and outer ring 2 and a transition fit is provided between outer ring 2 and stator 1. Due to this selection of fit, outer ring 2 initially remains stopped. Stator 1 starts to rotate first. Due to the contact of their outward-pointing ends 6 on walls 8 of grooves 7 situated in stator 1, locking elements 4 thus rotate on pivot points 14 and rotate back into the clamping/blocking position (see FIG. 2).

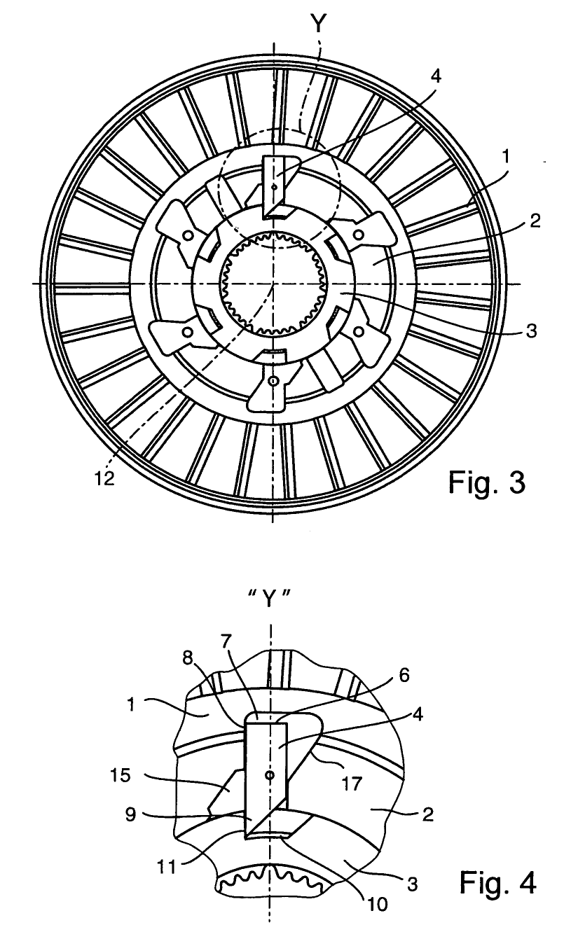

In the embodiment corresponding to FIG. 3, the freewheel is made up of stator 1, inner ring 3, blocking elements 4, and springs 15. In this embodiment, blocking elements 4 are supported and guided in stator 1. If it is attempted to rotate stator 1 to the left in counterclockwise direction, blocking elements 4 block the movement between stator 1 and internal ring 3 and thus prevent a rotational movement in that inward-pointing ends 9 of blocking elements 4 are in contact with walls 11 of grooves 10 situated in inner ring 3. If stator 1 is rotated to the right in clockwise direction, blocking elements 4 pivot when they strike beveled walls 16 of grooves 10 situated in inner ring 3. In freewheeling position, the centrifugal force causes blocking elements 4 to be rotated until outward-pointing ends 6 of blocking elements 4 are in contact with beveled walls 17 of grooves 7 situated in stator 1. In this position, inward-pointing ends 9 of blocking elements 4 do not engage grooves 10 situated in inner ring 3. Springs 15 attempt to rotate blocking elements 4 to the left in counterclockwise direction. In a change of direction from freewheeling to clamping/blocking, springs 15 press blocking elements 4 into grooves 10 situated in inner ring 3. Blocking elements 4 then reach the clamping position corresponding to FIG. 4. One advantage of this exemplary embodiment is that no outer ring is needed. Springs 15 are, of course, needed for this version; however, the manufacturing costs of the springs are clearly lower than those of the outer ring 2 of the first exemplary embodiment.

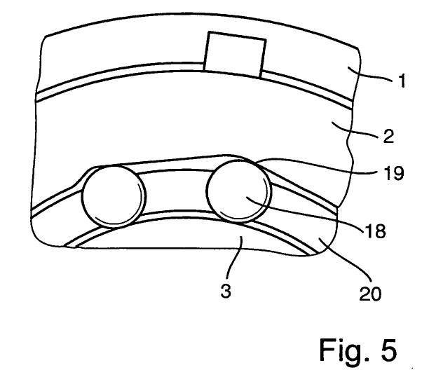

Another embodiment of a freewheel according to FIG. 5 is characterized in that blocking elements 4 are situated between outer ring 2 and inner ring 3 which wedge against ramps 19 in a corresponding direction of rotation of the two rings. In another embodiment, these ramps 19 are placed in outer ring 2. However, these ramps 19 mal also—in contrast to what is shown in the figure—be placed in inner ring 3. In connection with the present invention, it is important that the at least one blocking element 4 also has ramps 19 facing ramps 19 of the adjacent ring. With regard to the blocking element, FIG. 5 is somewhat misleading in that rollers 18 and spacers 20 are not separate parts but are instead made of one piece. Due to this design, rollers 18 slide (as already stated, they do not roll) on the surface of inner ring 3. At the same time, the “rollers” having their convex roundness facing the inside diameter of the outer ring represent ramps that are able to wedge against ramps 19 of outer ring 2.

### LIST OF REFERENCE NUMERALS

1 Stator
2 Outer ring
3 Inner ring
4 Blocking element
5 Recess in the outer ring
6 Outward-pointing end of the blocking element
7 Groove in the stator
8 Wall of the groove in the stator
9 Inward-pointing end of the blocking element
10 Groove in the inner ring
11 Wall of the groove in the inner ring
12 Axis of rotation
13 Bevel of the recess of the outer ring
14 Support point of the blocking element
15 Spring
16 Beveled wall of the groove in the inner ring
17 Beveled wall of the groove in the stator
18 Rollers
19 Inclined ramp
20 Spacer

What is claimed is:

1. A freewheel for a stator of a torque converter comprising:
a hub situated non-rotatably on a hollow shaft;
an outer ring connected to the stator and resistant to torsion; and
blocking elements situated between an outer diameter of the hub and an inner diameter of the outer ring creating a blocking between the hub and the outer ring, the blocking elements requiring an angle of rotation and a corresponding rotation of the outer ring relative to the hub in order to build up the blocking.

2. The freewheel as recited in claim 1 wherein at least one of the blocking elements exerts a rotation about an axis parallel to an axis of rotation of the stator, the at least one blocking element engaging grooves of the stator when rotating into a blocking position.

3. The freewheel as recited in claim 1 wherein the blocking elements are flat molded elements provided on a periphery of the freewheel.

4. The freewheel as recited in claim 1 wherein one of the blocking elements is supported in a recess of the outer ring.

5. The freewheel as recited in claim 4 wherein a contact surface of the recess in the outer ring is designed as a bevel.

6. The freewheel as recited in claim 1 further comprising an inner ring, different fits being provided between the inner ring, outer ring, and stator in such a way that the outer ring rotates more slowly than the stator in a change of direction.

7. The freewheel as recited in claim 6 wherein a clearance fit is provided between the inner ring and the outer ring.

8. The freewheel as recited in claim 1 wherein a transition fit is provided between the outer ring and the stator.

9. The freewheel as recited in claim 1 further comprising an inner ring having a groove with a wall and a stator groove with a stator wall, the wall and stator wall being perpendicular to an axis of rotation of the freewheel.

10. The freewheel as recited in claim 1-wherein in a change of direction of the rotation of the stator into freewheeling direction, at least one of the blocking elements pivots in the recess of the outer ring until it is in contact with the bevel of the recess of the outer ring and the inward-pointing end of the blocking element no longer engages the groove situated in the inner ring.

11. The freewheel as recited in claim 1 further comprising a spring, at least one of the blocking elements being supported and guided on the stator and acted upon by the spring in such a way that the blocking function is supported.

12. The freewheel as recited in claim 1 further comprising an inner ring with a groove, the stator having a stator groove, the groove and stator groove having beveled walls.

13. The freewheel as recited in claim 1 wherein only one of the blocking elements is present, which before the blocking action, exerts a rotation about an axis which is identical to the axis of rotation of the stator, ramps of the blocking element being wedged against ramps of the outer ring during the blocking.

14. A torque converter comprising a freewheel as recited in claim 1.
